(19) United States
(12) Patent Application Publication
(10) Pub. No.: US 2026/0289523 A1
(43) Pub. Date: Sep. 24, 2026

(54) SYSTEM AND METHOD FOR AUTOMATED ADVANCED DRIVER ASSISTANCE SYSTEM CALIBRATION MANAGEMENT

(71) Applicants: Joseph Brookhart, Avilla, IN (US); Casey L. Brothers, Fort Wayne, IN (US); Chad M. Luellen, Fort Wayne, IN (US)

(72) Inventors: Joseph Brookhart, Avilla, IN (US); Casey L. Brothers, Fort Wayne, IN (US); Chad M. Luellen, Fort Wayne, IN (US)

(21) Appl. No.: 19/369,874

(22) Filed: Oct. 27, 2025

Related U.S. Application Data
(60) Provisional application No. 63/775,441, filed on Mar. 21, 2025.

(51) Int. Cl. G06Q 10/20; B60S 5/00; G05B 13/02; G06Q 10/0631; H04L 9/06

(52) U.S. Cl. CPC G06Q 10/20; G05B 13/0265; G06Q 10/06316; H04L 9/0631; B60S 5/00

(57) ABSTRACT

A system and method for automated Advanced Driver Assistance System (ADAS) calibration management is disclosed, addressing inefficiencies in existing calibration workflows. The disclosed system integrates functionalities such as repair estimate parsing, VIN decoding, calibration flagging, workflow automation, compliance validation, liability management, real-time notifications, and analytics into a unified platform. The system includes components such as an ingestion module for data parsing and validation, a VIN decoding module for extracting vehicle-specific data, a calibration flagging module for identifying required calibration tasks, and a workflow automation engine for task assignment and prioritization. A compliance validation module ensures adherence to OEM standards, while a liability management module generates waivers for skipped calibrations. Real-time notifications and analytics provide insights into calibration trends and compliance metrics. The platform enhances operational efficiency, reduces errors, and ensures regulatory compliance, making the system suitable for use in vehicle repair environments. Secure data storage supports the platform's end-to-end functionality.

### CROSS-REFERENCE TO RELATED APPLICATIONS

This application claims benefit to Provisional Application No. 63/775,441, filed Mar. 21, 2025, the contents of which are herein incorporated by reference.

### BACKGROUND OF THE INVENTION

### Field of Endeavor

The present invention relates to automotive systems, and more particularly, to a comprehensive system and method for automated Advanced Driver Assistance System (ADAS) calibration management including repair workflow optimization, compliance assurance, and advanced analytics integration.

### Background of Related Art

Modern automotive systems have been significantly transformed by the integration of advanced driver assistance functionalities and sensor technologies. These systems rely on the precise calibration of various sensors and components to ensure optimal performance, safety, and compliance with regulatory standards. With vehicles becoming increasingly dependent on such sophisticated technologies, the accurate calibration of sensors plays a significant role not only in vehicle functionality but also in maintaining consumer trust and overall system integrity. As the automotive landscape continually evolves, there is a growing emphasis on aligning these calibration processes with the high safety and performance benchmarks demanded by today's market.

At the same time, stakeholders throughout the automotive industry, ranging from repair facilities to insurers, are striving to streamline the maintenance and calibration processes. There exists a clear objective to consolidate various procedures related to vehicle identification, calibration scheduling, and compliance validation into more coordinated workflows. By seeking to reduce the reliance on manual interventions and improve data integration across different functions, the industry is looking to enhance operational efficiency and accountability. This focus on more efficient systems reflects an industry-wide goal of ensuring calibration tasks are performed consistently, timely, and in strict accordance with established safety standards.

Despite technological advancements, many existing calibration management approaches remain fragmented and inefficient. Multiple methods addressing separate aspects of the overall calibration process often operate in isolation, leading to disjointed workflows. Critical functions—such as vehicle identification, data validation, and task prioritization—are handled by different systems that may not communicate effectively with one another. This lack of integration can lead to inconsistencies, delays, and an increased risk of human error. The disjointed nature of these processes poses challenges in achieving reliable calibration outcomes and maintaining the level of precision required in today's automotive service environments.

A specific challenge in this domain is ensuring that calibration protocols strictly adhere to the exacting standards set by vehicle manufacturers. The detailed requirements for calibration demand that each process be executed with a high degree of accuracy and continuously validated to meet rigorous performance criteria. When calibration tasks are managed through isolated, manually dependent systems, there is a risk of data fragmentation and oversight, which can lead to non-compliance. Such shortcomings not only jeopardize the accuracy of calibration records but also elevate the liability risks for service providers tasked with maintaining these systems. This situation underscores the need for a more unified, secure approach to manage calibration data and processes effectively while ensuring adherence to manufacturer standards.

### SUMMARY OF THE INVENTION

In one embodiment, the disclosure includes a system for automated ADAS calibration management in a vehicle repair environment. The system comprises a user interface module that receives a repair estimate and a specific vehicle identifier; an ingestion module that parses the repair estimate into line items and validates the vehicle identifier; a VIN decoding module that extracts vehicle-specific data from external sources; and a calibration flagging module that cross-references repair items with vehicle data to identify required calibration tasks. A workflow automation engine automatically assigns, prioritizes, and monitors those tasks, while a compliance validation module compares performed calibrations against OEM standards and generates compliance reports. A liability management module creates waiver documents for non-conforming tasks, and a real-time notification engine issues alerts for missing data, incomplete calibrations, or compliance failures. An analytics engine aggregates system data and produces performance and compliance metrics, and a secure data storage module retains repair estimates, vehicle data, calibration records, compliance reports, and liability waivers. In further embodiments, the ingestion module includes an optical character recognition engine; the workflow engine routes tasks to remote calibration providers via an integrated marketplace based on proximity, availability, or performance scores; the compliance module verifies environmental conditions such as lighting level, floor levelness, ambient temperature, and vibration threshold; the notification engine escalates overdue tasks to supervisory users; the analytics engine incorporates a predictive analytics sub-module forecasting non-compliance risk; and the storage module encrypts all data with AES-256 and maintains a tamper-evident audit log.

In another embodiment, the disclosure includes a method for automated ADAS calibration management. The method comprises receiving a repair estimate and vehicle identifier via a computing device; parsing the estimate into repair line items and validating the identifier; decoding the identifier to obtain vehicle-specific ADAS and calibration requirements; cross-referencing repair items with vehicle data to flag necessary calibrations; automatically generating, assigning, and prioritizing calibration tasks; upon task completion, verifying required environmental conditions and validating the calibration against OEM standards, with non-conforming calibrations flagged for review; generating a compliance report and, when standards are unmet, creating a liability waiver document; transmitting real-time notifications on missing data, incomplete calibrations, or validation errors; and aggregating and securely storing all related data. Further embodiments include prompting a user to confirm environmental conditions and logging that confirmation, as well as encrypting stored data with AES-256 under role-based access controls.

In a further embodiment, the disclosure includes a non-transitory computer-readable medium storing instructions that, when executed by a processor, cause a computing device to perform the automated calibration management method and to update a machine-learning knowledge base using feedback from compliance reports to refine future task assignments. These and other features will be more clearly understood from the following detailed description taken in conjunction with the accompanying drawings and claims.

### BRIEF DESCRIPTION OF THE DRAWINGS

FIG. 1 is a schematic diagram of an Automotive Calibration Environment, according to aspects of the present invention;

FIG. 2 is a method of Automotive Calibration, according to aspects of the present invention;

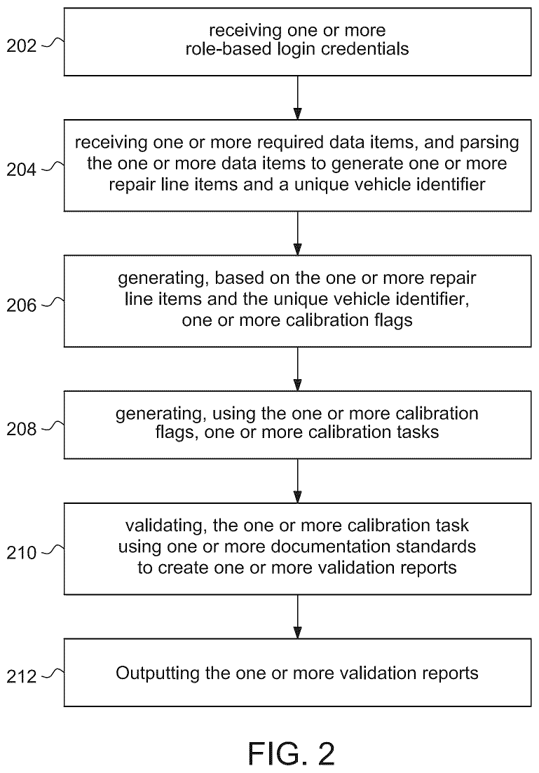

FIG. 3 is a diagram of one or more Role-based Dashboards, according to aspects of the present invention; and

FIG. 4 is a method of Liability Waiver Generation, according to aspects of the present invention.

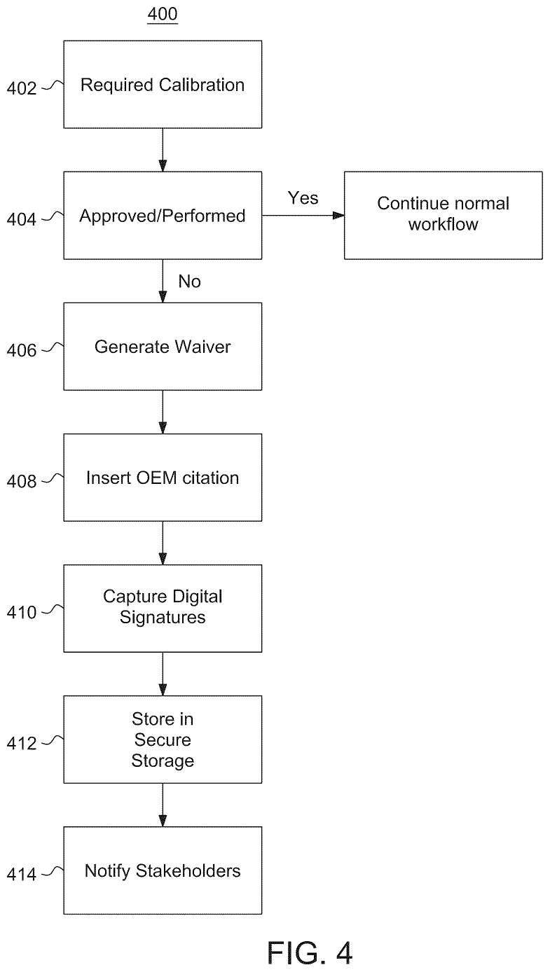

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

The field of Advanced Driver Assistance Systems (ADAS) calibration management has faced significant challenges due to the fragmented and inefficient nature of existing solutions. Conventional systems often rely on disconnected processes, manual data entry, and limited integration between important components such as vehicle identification, compliance validation, and workflow automation. These shortcomings result in operational inefficiencies, increased risk of human error, and non-compliance with Original Equipment Manufacturer (OEM) standards. For stakeholders such as body shops, insurers, and calibration providers, these limitations lead to missed calibrations, delayed workflows, and heightened liability concerns. Furthermore, the lack of centralized platforms for managing calibration requirements exacerbates data fragmentation, making it challenging to ensure the accuracy, consistency, and timeliness of calibration tasks.

The present system addresses these challenges by introducing a comprehensive approach for automated ADAS calibration management. This solution integrates functionalities such as VIN decoding, calibration flagging, workflow automation, and compliance validation, etc., into a unified platform. By leveraging advanced algorithms, real-time analytics, and role-based dashboards, the system streamlines operations, reduces errors, and ensures adherence to OEM standards. Unlike prior approaches, which often operate in silos, the described system employs a centralized architecture that facilitates seamless data flow between components, enabling efficient task prioritization, real-time notifications, and secure data storage. Additionally, the system incorporates machine learning mechanisms to continuously improve calibration recommendations and predictive analytics, further enhancing the precision and adaptability of the platform.

The system of the present invention employs modular architecture and method(s), performed by the architecture to provide seamless, and end-to-end ADAS calibration management. By addressing the limitations of existing systems and introducing a robust, integrated solution, the described system enhances the efficiency, accuracy, and reliability of ADAS calibration management processes.

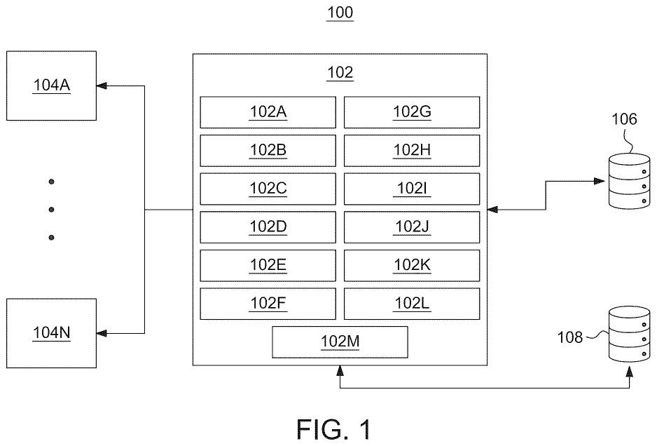

FIG. 1 illustrates an Automotive Calibration Environment 100, according to aspects of the present invention. Broadly, the Automotive Calibration Environment 100 is a computing environment, or computing system, having an Automotive Calibration System 102 accessible by one or more user devices 104A-N to perform, monitor, and/or manage one or more automotive calibration functions. The Automotive Calibration System 102 includes one or more modules 102A-M, engines, or functions, configured to perform one or more functionalities related to automotive calibration, described further hereinafter. The Automotive Calibration System 102 can query and/or retrieve information from one or more data sources, such as data source 106, and/or one or more external data source(s) 108.

The components of the Automotive Calibration Environment 100 can communicate through one or more communications devices, using one or more communications protocols via wired, and/or wireless communication(s), such as through a network, i.e. the Internet. In embodiments, the one or more communication devices allow Automotive Calibration System 102 to communicate with other devices and systems. The one or more communication devices can include, for example, a networking chip, one or more antennas, and/or one or more communication ports. The one or more communication devices can generate radio frequency (RF) signals and transmit the RF signals via one or more of the antennas. The one or more communication devices can generate electronic signals and transmit the RF signals via one or more of the communication ports. The one or more communication devices can receive the RF signals from one or more of the communication ports. The electronic signals can be transmitted to and/or from a communication hardline by the communication ports. The one or more communication device can generate optical signals and transmit the optical signals to one or more of the communication ports. The one or more communication devices can receive the optical signals and/or can generate one or more digital signals based on the optical signals. The optical signals can be transmitted to and/or received from a communication hardline by the communication port, and/or the optical signals can be transmitted and/or received across open space by the one or more communication devices.

The one or more communication devices can include hardware and/or software for generating and communicating signals over a direct and/or indirect network communication link. As used herein, a direct link can include a link between two devices where information is communicated from one device to the other without passing through an intermediary. For example, the direct link can include a Bluetooth™ connection, a Zigbee connection, a Wifi Direct™ connection, a near-field communications (“NFC”) connection, an infrared connection, a wired universal serial bus (“USB”) connection, an ethernet cable connection, a fiber-optic connection, a firewire connection, a microwire connection, and so forth. In another example, the direct link can include a cable on a bus network. An indirect link can include a link between two or more devices where data can pass through an intermediary, such as a router, before being received by an intended recipient of the data. For example, the indirect link can include a WiFi connection where data is passed through a WiFi router, a cellular network connection where data is passed through a cellular network router, a wired network connection where devices are interconnected through hubs and/or routers, and so forth. The cellular network connection can be implemented according to one or more cellular network standards, including the global system for mobile communications (“GSM”) standard, a code division multiple access (“CDMA”) standard such as the universal mobile telecommunications standard, an orthogonal frequency division multiple access (“OFDMA”) standard such as the long term evolution (“LTE”) standard, and so forth.

Automotive Calibration System 102 includes a plurality of modules, engines, components, etc., such as core modules 102A-102F, configured to perform, monitor, manage, or otherwise interact with an automotive calibration. Broadly, and described in more detail below, Automative Calibration System 102 receives input(s) from a user(s) in the form of a repair estimate, and a unique vehicle identifier. System 102 utilizing the plurality of modules ingests the input(s), determines one or more action items based on the ingested input(s), and performs/manages/monitors the one or more action items through one or more workflows resulting in a validated and completed action item.

Ingestion Module 102A receives one or more inputs into system 102. In embodiments, the one or more inputs are: one or more files, such as one or more vehicle repair estimates having one or more repair line items therein; and at least one unique vehicle identifier, such as a Vehicle Identification Number (VIN). In embodiments, the one or more files are uploaded to the system 102 in one or more known file formats (RDF, image, jpeg, DOC, etc.), or alternatively the one or more files can be manually input into system 102. Additionally, the at least one unique vehicle identifier can be entered manually into system 102, or alternatively, automatically entered using one or more VIN compatible scanners.

Once the one or more inputs are ingested, Ingestion Module 102A performed one or more of parsing and/or validation logic. In embodiments, the one or more files are passed to one or more parsing modules configured to extract the one or more repair line items from the one or more files. In embodiments, the one or more parsing modules execute Optical Character Recognition (OCR) to extract the one or more repair line items from the one or more files. Alternatively, the one or more parsing modules utilize Intelligent Character Recognition (ICR), Machine Learning, Artificial Intelligence, and/or Natural Language Processing (NLP) to extract the one or more repair line items from the one or more files.

The unique vehicle identifier is passed to validation logic of the Ingestion Module 102A. In embodiments, the validation logic verifies the proper structure of the unique vehicle identifier. In an exemplary embodiment, validation logic verifies the unique vehicle identifier, as a VIN, is a proper length, i.e. has 17 characters, and that the characters are formatted properly. If the validation logic finds an error in the unique vehicle identifier, a flag is issued, and a real-time notification or alert is provided to one or more users, who can act on the error. Once parsing and validation is completed, the Ingestion Module 102A outputs and/or stores the one or more repair line items, and the unique vehicle identifier for use by other modules, or engines, of system 102.

VIN Decoding Module 102B utilizes the unique vehicle identifier to extract, or retrieve, one or more vehicle specific items. In embodiments, the one or more vehicle specific items can be one or more of the following: vehicle specifications, ADAS information (such as calibration information), OEM information, vehicle part information, etc. In embodiments, the VIN Decoding Module 102B utilizes one or more portions of the unique vehicle identifier to query one or more data sources, such as database 106 and/or external data sources 108 to retrieve the one or more vehicle specific items. In embodiments, external data sources 108 include, but are not limited to: real-time data sources, manufacture databases, government databases, trade databases, etc. The one or more vehicle specific items can output and/or stored by VIN Decoding Module 102B for use by other modules, or engines, of system 102.

Calibration Flagging Module 102C utilizes the one or more vehicle specific items and the one or more repair line items to determine one or more action items. In embodiments, Calibration Flagging Module 102C utilizes logic-based analysis to cross-reference the one or more repair line items with the one or more vehicle specific items to determine the one or more action items. In embodiments, the one or more repair line items include one or more ADAS features of a vehicle and the one or more vehicle specific items include one or more ADAS calibration requirements, which are matched by the Calibration Flagging System 102C to determine one or more flagged calibration tasks, as the one or more action items. In embodiments, the analysis includes one or more rules to automatically flag items for required action, i.e. one or more calibration tasks. The one or more flagged action items, such as flagged calibration tasks can be output and/or stored by Calibration Flagging Module 102C for use by other modules, or engines, of system 102.

Workflow Automation Engine 102D is configured to provide workflow support to system 102 by automating task assignment, task prioritization, tracking progress, etc., for the one or more flagged action items (i.e. flagged calibration tasks). Workflow Automation Engine 102D assigns each of the one or more flagged action items to one or more users based on the user roles (such as technicians, repair teams, etc.) through one or more dashboards, described further hereinafter. Workflow Automation Engine 102D uses one or more prioritization factors to, automatically, prioritize the one or more flagged action items. In embodiments, the one or more prioritization factors include, but are not limited to: complexity, urgency, and/or task dependency. Workflow Automation Engine 102D provides one or more notifications for the one or more flagged action items to one or more users, such as alerts when a task is finished, needs attention, overdue, or delayed. Additionally, Workflow Automation Engine 102D is configured to manage Calibration Fulfillment Marketplace 102L, described further hereinafter. Finally, Workflow Automation Engine 102D links the one or more flagged action item to the Compliance Validation Tool 102F, describe further hereinafter, to ensure accurate execution.

Compliance Validation Module 102F is configured to perform one or more validations, such as validating the one or more flagged action items against standards documentation, such as OEM standards, to ensure compliance with standards. Compliance Validation Module 102F receives one or more completed flagged action items from Workflow Automation Engine 102D, which are cross-referenced against standards documentation to determine the validity of the performed action item. In embodiments, standards documentation includes, but is not limited to, OEM documentation regarding proper validation techniques, equipment, etc. Compliance Validation Module 102F includes verification logic used in the one or more validations. In embodiments, the verification logic determines if one or more flagged action items is non-compliant, or if one or more data items are missing. In each case the one or more validation(s) is flagged for further review, and/or manual input. For flagged action items that do not meet standards documentation, the Compliance Validation Module 102F flag one or more issues and/or suggests corrective actions.

Compliance Validation Module 102F provides one or more outputs, such as validation reports, alerts, notifications, etc., associated with the one or more validations. In embodiments, validation report(s) include a calibration report with references to standards documentation used in the one or more validations, or notification that data items are missing from the validation. The report becomes a legal and compliance document that protects a user (i.e. the body shop or calibration provider) by showing what was required, what was done, and who made the decision to approve or deny the work.

Real-time Notification Engine 102G is configured to send notifications, alerts, etc., to and from System 102 and/or one or more of the plurality of modules thereof. In embodiments, Real-time Notification Engine 102G receives data indicative of an notification, or alert, from System 102 and and/or one or more of the plurality of modules and provides a notification, or alert, based on the data. In embodiments, notifications, or alters include alerts for missing data, incomplete calibrations, one or more validation errors. For example, notifications can include that a required flagged action item, i.e. calibration, is missing from an estimate; notifications can include OEM documentation, used by Compliance Validation Module 102F, cannot be confirmed; notifications can include one or more recommendations or suggestions from the system 102 to resolve the one or more errors; or escalation notifications for overdue tasks.

Analytics Engine 102E is configured to aggregate data across system 102 and/or one or more of the plurality modules, and generate insights into calibration trends, compliance rates, and cost metrics. Analytics Engine 10E receives data from Compliance Validation module 102F and/or Workflow Automation Engine 102E and using this data generates metrics related to action item(s), i.e. calibration. In embodiments, the metrics include, but are not limited to calibration success rates, cost analyses, performance trends and/or calibration trends. Additionally, Analytics Engine 102E utilizes the aggregated date to determine one or more insights, and provides the one or more insights to users, system 102, and/or one or more of the plurality of modules. In embodiments, the one or more insights are one or more reports, such as custom reports based on a user-role, i.e. reports can be customized for insurers, managers, compliance, repair shops, etc.

Learning Engine (102I) is configured to utilize one or more machine learning and/or artificial intelligence algorithms to operate one historical data items, such as user-provided solutions and feedback, to improve future recommendations. In embodiments, the one or more historical data items are stored in database 106. Learning Engine 102I uses the one or more historical data items to identify recurring issues and suggest best practices. In embodiments, the Learning Engine 102I enhances the intelligence of the Workflow Automation Engine and Analytics Dashboard by improving accuracy and efficiency over time. Advantageously, Learning Engine 102I is a self-updating internal knowledge base that captures all data from system 102 and reuses the captured data to assist in future cases, reducing repetitive decision-making.

Predictive Analytics Engine 102J is configured to aggregate flagged action item data throughout system 102 and provide one or more outputs. In embodiments, the one or more outputs are one or more dashboards and/or forecasting tools using aggregate calibration data to predict costs, denial trends, recurring repair patterns, and workflow bottlenecks-enabling data-driven process improvement.

Liability Management Module 102K is configured to generate one or more liability waivers based on data from the Calibration Validation Module 102F. In embodiments, Liability Management Module 102K interfaces with Calibration Validation Module 102F to receive the one or more non-compliant action items. In embodiments, the one or more non-compliant action items are indicative of an action item, such as a calibration, not being performed. In cases where the action item, i.e. calibrations, are not performed (e.g., denied by insurer or declined by customer), Liability Management Module 102K is configured to automatically generate a compliance document. In embodiments, the compliance document is a calibration waiver, which documents: What procedure was skipped; Why it was required (with OEM reference); Who declined the procedure (i.e. which user, insurer, customer, shop). Additionally, Liability Management Module 102K collects digital signatures from each user responsible for the non-compliant action item, and stores the signed compliance document securely, i.e. in database 106, for legal and compliance purposes. Advantageously, Liability Management Module 102K is an automated waiver system that generates digital legal documents when required calibrations are skipped, documenting liability assignment (e.g., to insurer or vehicle owner) with digital signature capture and OEM citations.

In an exemplary embodiment, Liability Management Module 102K is configured to perform method 400. Method 400 starts with a request for calibration 402. At 404, a determination is made as to whether the request was approved and/or performed, and if so normal workflow proceeds through system 102. If the determination is that the request was not approved and/or performed, waiver generation begins at 406. At step 408, an OEM citation is inserted into the waiver, indicating why the request was needed. At step 410, one or more digital signatures from one or more users is captured on the waiver. In embodiments, the one or more signatures can include signatures from one or more users responsible for declining the request. At step 412, the waiver is stored in secure storage, such as database 106. Finally, at step 414 one or more stakeholders are notified of the waiver.

Calibration Fulfillment Marketplace 102L is configured the one or more flagged action items from the Workflow Automation Engine 102E and manage one or more job assignments associated with the one or more flagged action items. In embodiments, Calibration Fulfillment Marketplace 102L enables real-time collaborations between one or more users of system 102, such as collision centers who provide inputs to the system 102 which form the basis of the one or more flagged action items, and calibration providers who perform the one or more flagged action items.

In operation, Calibration Fulfillment Marketplace 102L receives the one or more flagged action items from the Workflow Automation Engine 102E, and transforms each flagged action item or group of action items into one or more job ticket(s). In embodiments, the one or more job ticket(s) are assigned manually or auto-routed to calibration providers based on one or more parameters. In embodiments, the one or more parameters are one or more of: a location, an availability, or a past performance. Calibration providers utilize the Calibration Fulfillment Marketplace 102L to accept jobs, schedule appointments for one or more job tickets, or update completion status of one or more job tickets. Calibration Fulfillment Marketplace 102L is configured to provide one or more notifications, to system 102 which are provided to one or more users using the Real-time Notification Engine 102G.

Calibration Requirement and Compliance Monitoring Module 102M is configured to identify and enforce environmental and operational conditions required by OEMs for accurate ADAS calibration. In embodiments, the environmental and operational conditions are one or more of: proper lighting levels, level flooring, minimal vibration or movement, and/or temperature and weather considerations (for mobile calibrations).

In operation, when the one or more flagged action items triggers a calibration action item, such as an ADAS calibration action, Calibration Requirement and Compliance Monitoring Module 102M automatically: Lists the required conditions specific to the procedure; Prompts a user to confirm or document whether the conditions were met; and Log the calibration as “valid,” “conditionally valid,” or “invalid” based on the environmental input.

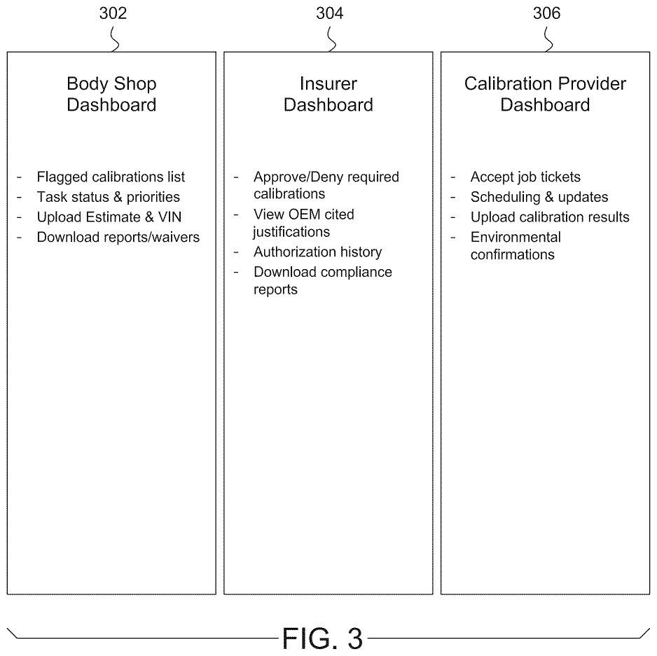

System 102 includes Role-based Access Controls (RBAC) configured to provide access to one or more of the plurality of modules, reports, etc., based on role of the user. In embodiments, one or more user(s) access the system and/or modules through customized dashboards. This permissions-based framework that presents each user type (body shop, insurer, calibration provider) with a tailored dashboard, customized functionality, and limited access to ensure secure and efficient workflow separation, as illustrated in FIG. 3. In exemplary embodiments, the one or more users are one or more of Body Shops 302, Insurers 304, Calibration Companies 306, etc., each having access to and/or performable functionalities based on their roles. For example, Body Shop users role can upload one or more repair estimates, view one or more flagged action items, such as required calibrations, download reports, issue waivers, as illustrated at 302; Insurers users can Approve/deny flagged action items, i.e. calibrations, review justifications for approval/denial, track authorization history, as illustrated at 304; and Calibration Companies can Accept job assignments, access documentation, upload results, as illustrated at 206. Advantageously, the RBAC protects sensitive work flows and ensures secure interactions between users and system components.

Data source 106 is a database configured to save and provide all data from system 102, and/or one or more of the plurality of modules therein. In embodiments, Data source 106 is an encrypted database utilizing one or more encryption algorithms, such as AES, 3DES, RSA, etc., to encrypt the data stored therein. In embodiments, Data source 106 provides data to system 102 and/or one or more of the plurality of modules based on RBAC. Data sources 106, and/or 108 may be database(s) in any data format such as, for example, binary data, comma delimited data, tab delimited data, structured query language (SQL) structures, etc. While, in the illustrated example, the database(s) 106 and 108 are illustrated as single device(s), the example database(s) 106 and/or 108 and/or any other data storage devices described herein may be implemented by any number and/or type(s) of memories. Advantageously, the Data source 106 serves as a secure repository for data generated by all components of the system, ensuring compliance with privacy standards.

Automotive Calibration Environment 100 is utilized to perform one or more methods, which can be executed, for example, by Automotive Calibration System 102. Broadly, and described in more detailed below, a method of automotive component calibration 200 is provided. Briefly, the method of automotive component calibration 200 receives one or more data items associated with an automobile, which are processed to determine one or more calibration actions needing to be performed. The one or more calibration actions generate one or more tasks, performable by one or more users, which are tracked, analyzed, monitored, validated, and/or verified through the calibration process. The method 200 results in one or more outputs, such as reports, compliance documentation, etc., documenting, outlining, or otherwise providing insight one the calibration process.

Method 200 begins at step 202, with one or more user(s) accessing a system, such as system 102. The one or more user(s) access the system through one or more login credentials, which are tied to one or more role-specific functionalities. In embodiments, one or more secure interfaces are provided for the one or more user(s) to select a role, and/or utilize the one or more login credentials. In embodiments, the one or more login credentials and/or one or more role-specific functionalities are provided (e.g., body shop, insurer, or calibration provider) by the RBAC of system 102. In embodiments, functionalities of the system of the present invention vary depending on the role selected by the one or more user(s). For example, one or more modules, engines, dashboards, and/or features, are customized based on the role of the one or more user(s), i.e. displaying relevant tools (e.g., flagged calibrations for body shops or compliance reports for insurers).

At step 204, once the one or more user(s) are logged in to the system, the one or more users can input one or more required data and/or the required data can be automatically input. In embodiments, the one or more required data can include a repair estimate, and/or a unique vehicle identifier, such as a VIN. In embodiments, the repair estimate can be uploaded to the system in one or more known file formats (PDF, image, or file). In embodiments, the repair estimate can be entered into the system using one or more automated document processing algorithms. For example, Optical Character Recognition can be utilized to automatically determine one or more repair line items from the repair estimate. In embodiments, the vehicle's VIN can be entered manually or automatically using one or more compatible VIN scanner(s). In embodiments, the system, using the VIN Decoding module can validate the vehicle's VIN for proper length (17 characters) and formatting. In embodiments, step 204 is performed using Ingestion Module 102A, including the functionality described therewith. In embodiments, an output of step 204 is the one or more repair line items and the unique vehicle identifier.

At step 206, one or more calibration flags are generated utilizing the one or more repair line items and the unique vehicle identifier. In embodiments, the system, using the VIN Decoding Module 102B, decodes the vehicle's unique identifier, i.e. VIN, to identify vehicle specifications, ADAS information (such as calibration information), OEM information, vehicle part information, etc., as one or more calibration flags. Additionally, the one or more calibration flags are cross-referenced against one or more repair actions with the one or more ADAS features to flag required calibrations. In embodiments, step 206 is performed by VIN Decoding module 102B and Calibration Flagging Module 102C including the functionality associated therewith. In embodiments, the one or more calibration flags are be provided to the one or more user(s) the dashboard, such as through the Analytics Engine 102H, a Reporting Dashboard, or Real-time Notification Engine 102G which can be categorized by urgency and complexity.

At step 208, the list of one or more calibration flags and one or more calibration tasks are created. In embodiments, the one or more calibration tasks are managed, monitoring, tracked, prioritized, etc. In embodiments, the one or more calibration tasks are provided to, and/or generated by the Workflow Automation Engine 102E, which manages, monitors, tracks, prioritizes, etc., the one or more calibration tasks. In embodiments, through the Workflow Automation Engine 102E assign(s) and/or Calibration Fulfillment Marketplace 102L one or more flagged calibrations are assigned to one or more additional user(s), such as a technician(s) or team(s). In embodiments, one or more tasks can be prioritized based on urgency and dependencies (e.g., radar alignment before camera aiming), and can be monitored in real-time using the Analytics Engine 102H and the Reporting Dashboard. In embodiments, one or more notifications can be provided for any delayed or incomplete tasks, utilizing Real-time Notification Engine 102G. In embodiments, part of all of step 208 includes functionalities provided by Workflow Automation engine 102E, and/or Calibration Fulfillment Marketplace 102L and all of the functionalities associated therewith. As a result of step 208, the one or more calibration tasks are completed and provided for validation or verification.

At step 210, the one or more calibration tasks are validated for compliance with one or more standards. In embodiments, the Compliance Validation Module 102F automatically validate each calibration task by cross-referencing the one or more calibration tasks against the one or more standards, such as OEM requirements. In embodiments, the one or more standards include information such as: proper validation techniques, equipment used in calibration, etc.

Results of validation include one or more calibration report(s) with references to standards data using in validation, or notification that a calibration is not compliant, i.e. data items are missing from the validation, one or more standards were not complied with, etc. If data is missing, or if calibration is non-compliant, the calibration is flagged for further review, and/or manual input. For calibrations that do not meet standards, the system flags issues and suggests corrective actions. The one or more calibration report(s) becomes a legal and compliance document that protects the body shop or calibration provider by showing what was required, what was done, and who made the decision to approve or deny the work.

At step 212, the one or more calibration report(s) are provided to the one or more user(s). In embodiments, the one or more user(s) can download a detailed compliance report, which can include one or more calibration details and validation results. In embodiments, step 210 includes functionalities provided by Compliance Validation Module 102F and all functionalities associated therewith.

The present invention includes numerous advantages over prior art systems, including, but not limited to: End-to-End calibration workflow automation which goes beyond basic VIN decoding to include estimate parsing, compliance validation, waiver generation, and job fulfillment in one continuous process; Real-Time OEM compliance validation with live verification against OEM calibration requirements, with fallback handling for incomplete data (not just static flagging); Environmental condition enforcement for tracking OEM-required environmental calibration conditions (lighting, level surface, etc.), ensuring calibration integrity; Automatic liability waiver generation when calibrations are declined the present invention automatically generates waivers and tracks/stores the waiver process, clearly assigning liability-a legal and compliance safeguard missing in other tools; Role-Based dashboards and secure access control providing customized user experiences with limited, secure access based on a user role (e.g., body shop, insurer, calibrator), enhancing efficiency and security; Live calibration job assignment marketplace providing a unique live job dispatch system for connecting calibration needs with qualified providers in real time-ensuring calibrations are completed, not just identified; a Learning Engine for manual overrides which stores manually entered solutions to build a dynamic knowledge base that improves accuracy and decision-making over time; Predictive analytics and compliance scoring which tracks performance trends, forecasts costs, and rates users (i.e. shops and providers) based on adherence to compliance standards and workflow behavior.

By way of example and not limitation, an end-to-end use case is provided to illustrate operation of the system 102 in a collision repair scenario. A body shop user uploads a repair estimate listing replacement of one or more components, such as: a front radar unit and a windshield-mounted camera and enters the vehicle VIN via a user interface module of system 102. The ingestion module 102A parses the estimate into repair line items and validates the VIN format; if incorrectly formatted, a flag is issued and the real-time notification engine 102G alerts the user to correct the VIN prior to proceeding. The VIN decoding module 102B retrieves vehicle-specific ADAS data (e.g., presence of radar/camera and related calibration requirements). The calibration flagging module 102C cross-references the repair line items with the vehicle-specific data and flags required calibrations for the radar and camera.

The workflow automation engine 102D generates corresponding calibration tasks, assigns them to in-house personnel or, when needed, routes a task through the calibration fulfillment marketplace 102L to a qualified external provider based on proximity, availability, or performance. Upon completion, the technician uploads results and sensor-alignment data; the compliance validation module 102F verifies each calibration against OEM standards and, via the calibration requirement and compliance monitoring module 102M, records whether OEM-required environmental conditions (e.g., lighting, level floor, temperature, vibration limits) were satisfied. Non-conforming calibrations are flagged with suggested corrective actions.

The system then generates a calibration compliance report that details required actions, outcomes, and OEM references and stores the report in secure data storage 106. If a flagged calibration is not performed (e.g., declined by an insurer), the liability management module 102K automatically generates a digital liability waiver that identifies the omitted procedure, cites the OEM requirement, captures digital signatures of responsible parties, and stores the signed waiver. The analytics engine 102E aggregates data for performance and compliance metrics, and the learning engine 102I and predictive analytics engine 102J iteratively improve recommendations and forecast non-compliance risk for future jobs.

Broadly, an embodiment of the system of the present invention may be a computing system, including: one or more servers, and/or at least one computer. Each server and computer of the present invention may each include computing systems. This disclosure contemplates any suitable number of computing systems. This disclosure contemplates the computing system taking any suitable physical form. As example and not by way of limitation, the computing system may be a virtual machine (VM), an embedded computing system, a system-on-chip (SOC), a single-board computing system (SBC) (e.g., a computer-on-module (COM) or system-on-module (SOM)), a desktop computing system, a laptop or notebook computing system, a smart phone, an interactive kiosk, a mainframe, a mesh of computing systems, a server, an application server, a cloud computing system or a combination of two or more of these. Where appropriate, the computing systems may include one or more computing systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example, and not by way of limitation, one or more computing systems may perform in real time or in batch mode one or more steps of one or more methods described or illustrated herein. One or more computing systems may perform at different times or at different locations one or more steps of one or more methods described or illustrated herein, where appropriate.

In certain embodiments, the network may refer to any interconnecting system capable of transmitting audio, video, signals, data, messages, or any combination of the preceding. The network may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

In some embodiments, the computing systems may execute any suitable operating system such as IBM's zSeries/Operating System (z/OS), MS-DOS, PC-DOS, MAC-OS, WINDOWS, UNIX, OpenVMS, an operating system based on LINUX, or any other appropriate operating system, including future operating systems. In some embodiments, the computing systems may be a web server running web server applications such as Apache, Microsoft's Internet Information Server™, and the like.

In particular embodiments, the computing systems includes a processor, a memory, a user interface and a communication interface. In particular embodiments, the processor includes hardware for executing instructions, such as those making up a computer program. The memory includes main memory for storing instructions such as computer program(s) for the processor to execute, or data for processor to operate on. The memory may include mass storage for data and instructions such as the computer program. As an example, and not by way of limitation, the memory may include an HDD, a floppy disk drive, flash memory, an optical disc, a magneto-optical disc, magnetic tape, a Universal Serial Bus (USB) drive, a solid-state drive (SSD), one or more computer-readable media, or a combination of two or more of these. The memory may include removable or non-removable (or fixed) media, where appropriate. The memory may be internal or external to computing system, where appropriate. In particular embodiments, the memory is non-volatile, solid-state memory.

As used herein, the term machine-readable media, computer-readable media, or the like may refer to any component, device or other tangible media able to store instructions and data temporarily or permanently. Examples of such media may include, but is not limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “computer-readable media” should be taken to include a single medium or multiple media (e.g., a centralized or distributed database, or associated caches and servers) able to store instructions. The term “computer-readable medium” may also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “computer-readable media” may refer to a single storage apparatus or device, as well as “cloud-based” storage systems or storage networks that include multiple storage apparatus or devices. The term “computer-readable media” excludes signals per se.

The user interface includes hardware, software, or both providing one or more interfaces for communication between a person and the computer systems. As an example, and not by way of limitation, a user interface device may include a keyboard, keypad, microphone, monitor, mouse, printer, scanner, speaker, still camera, stylus, tablet, touchscreen, trackball, video camera, another suitable user interface or a combination of two or more of these. A user interface may include one or more sensors. This disclosure contemplates any suitable user interface and any suitable user interfaces for them.

One or more Application Programming Interface(s) (API) are configured to provide integration with one or more components external to the system 102. In embodiments, the one or more APIs Integration can retrieve one or more data items from external, or third-party, tools (e.g., diagnostic APIs, OEM databases). In embodiments, upon failure of the one or more APIs, manual input can be provided to the system of the one or more external data items.

The communication interface includes hardware, software, or both providing one or more interfaces for communication (e.g., packet-based communication) between the computing systems over the network. As an example, and not by way of limitation, the communication interface may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface. As an example and not by way of limitation, the computing systems may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computing systems may communicate with a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination of two or more of these. The computing systems may include any suitable communication interface for any of these networks, where appropriate.

It should be understood, of course, that the foregoing relates to exemplary embodiments of the invention and that modifications may be made without departing from the spirit and scope of the invention as set forth in the following claims.

What is claimed is:

1. A system for automated advanced driver assistance system (ADAS) calibration management, comprising:
a user interface module, configured to receive, from one or more user devices, a repair estimate and a specific vehicle identifier;
an ingestion module, operatively coupled to the user interface module and configured to:
parse the repair estimate into one or more repair line items; and
validate the distinct vehicle identifier;
a VIN decoding module, operatively coupled to the ingestion module and configured to decode the vehicle identifier to extract one or more data items specific to the vehicle from one or more external data sources;
a calibration flagging module, operatively coupled to the VIN decoding module and the ingestion module and configured to cross-reference the one or more repair line items with the one or more vehicle-specific data to determine one or more required calibration tasks;
a workflow automation engine, operatively coupled to the calibration flagging module and configured to:
automatically assign the one or more required calibration tasks;
prioritize the one or more required calibration tasks; and
monitor the one or more required calibration tasks based on predetermined criteria;
a compliance validation module, operatively coupled to the workflow automation engine and configured to:
compare one or more performed calibration tasks against one or more calibration standards; and
generate corresponding compliance reports;
a liability management module, operatively coupled to the compliance validation module and configured to automatically generate a liability waiver document for any calibration task not performed in accordance with the OEM standards;
a real-time notification engine, operatively coupled to at least one of the ingestion module, workflow automation engine, and compliance validation module and configured to transmit alerts related to:
missing data;
incomplete calibrations; and
non-compliance events;
an analytics engine, operatively coupled to the workflow automation engine and the real-time notification engine and configured to:
aggregate system data; and
generate performance and compliance metrics; and
a secure data storage module, operatively coupled to the user interface module, the ingestion module, the VIN decoding module, the calibration flagging module, the workflow automation engine, the compliance validation module, the liability management module, and the analytics engine and configured to store:
the repair estimates;
vehicle-specific data;
calibration records;
compliance reports; and
liability waivers,
wherein the system integrates VIN decoding, repair estimate parsing, calibration flagging, workflow automation, compliance validation, liability management, real-time notification, analytics, and secure data storage into a unified platform for automated end-to-end ADAS calibration management in a vehicle repair environment.

2. The system of claim 1, wherein the ingestion module further comprises an optical character recognition engine configured to extract the one or more repair line items from an uploaded image-based repair estimate.

3. The system of claim 1, wherein the workflow automation engine is further configured to automatically route each of the one or more required calibration tasks to a remote calibration provider through an integrated marketplace based on at least one of:
geographic proximity of the provider to the vehicle location;
real-time availability of the provider; and
a historical performance score of the provider.

4. The system of claim 1, wherein the compliance validation module is further configured to verify that environmental conditions associated with each performed calibration task satisfy at least one OEM-specified parameter selected from lighting level, floor levelness, ambient temperature, and vibration threshold.

5. The system of claim 1, wherein the real-time notification engine is configured to escalate an alert to a supervisory user when any calibration task remains incomplete beyond a predetermined time threshold.

6. The system of claim 1, wherein the analytics engine further comprises a predictive analytics sub-module configured to forecast a probability of calibration non-compliance for an incoming repair estimate based on historical calibration data stored in the secure data storage module.

7. The system of claim 1, wherein the secure data storage module encrypts all stored data using Advanced Encryption Standard-256 (AES-256) and maintains a tamper-evident audit log of each data access attempt.

8. A method for automated advanced driver assistance system (ADAS) calibration management, comprising:
receiving, via a computing device, a repair estimate and a specific vehicle identifier for a vehicle;
ingesting the repair estimate and the specific vehicle identifier, by parsing the repair estimate into a plurality of repair line items, and validating that the specific vehicle identifier conforms to a predetermined format;
decoding the vehicle identifier to extract one or more data items specific to the vehicle, wherein the one or more data items specific to the vehicle includes information indicative of ADAS features and calibration requirements;
cross-referencing the plurality of repair line items with the one or more specific data items to automatically identify one or more calibration flags that indicate required ADAS calibrations;
automatically generating a plurality of calibration tasks from the one or more calibration flags, and assigning the one or more calibration tasks to one or more technicians based on task prioritization criteria;
upon completion of an assigned one or more calibration task, verifying that environmental conditions required for proper calibration are met and validating the performed calibration by comparing the calibration process to predetermined OEM standards, whereby nonconforming calibrations are flagged for further review;
generating a calibration compliance report that reflects the results of the compliance validation and, in cases where an assigned calibration task is not performed in accordance with the predetermined standards, automatically generating a liability waiver document incorporating task details and associated digital signatures of the responsible parties;
transmitting real-time notifications to one or more users regarding statuses such as missing data, incomplete calibrations, and validation errors; and
aggregating and securely storing data relating to the repair estimate, the plurality of repair line items, the identified calibration flags, the calibration tasks, the compliance validation results, and the liability waiver document.

9. The method of claim 8, further comprising, prior to validating the performed calibration, automatically prompting a user to confirm fulfillment of OEM-required environmental conditions and logging the user's confirmation in the calibration compliance report.

10. The method of claim 8, wherein aggregating and securely storing the data further comprises encrypting the data with AES-256 and permitting decryption only for sessions authenticated through role-based access controls.

11. A non-transitory computer-readable medium storing instructions that, when executed by at least one processor, cause a computing device to perform the method of claim 8.

12. The non-transitory computer-readable medium of claim 11, wherein the instructions further cause the computing device to update a machine-learning knowledge base using feedback contained within the calibration compliance report and to employ the updated knowledge base to refine calibration task assignments for subsequent vehicles.
